(19) United States
(12) Patent Application Publication
(10) Pub. No.: US 2008/0047178 A1
(43) Pub. Date: Feb. 28, 2008

(54) Ring, container and method for identifying the container

(76) Inventor: Christopher Marszalek, Plainfield, IL (US)

Correspondence Address: Patents+TMS;A Professional Corporation, 2849 W. Armitage Ave., Chicago, IL, 60647, US

(21) Appl. No.: 11/509,491

(22) Filed: Aug. 24, 2006

(51) Int. Cl. G09F 3/00

(52) U.S. Cl. 40/310

(57) ABSTRACT

A ring, a container and a method identify the container from other containers. A top end of the container is inserted into and/or is positioned within an interior of the ring for connecting the ring to the container. A tab is connected to the ring to be grasped by and/or to be held by the user of the ring for positioning and/or for inserting the top portion of the container within the interior of the container. The ring and/or the tab of the ring displays a first color and/or first indicia which is indicative of and/or identified with the user of the ring. The user identifies that the container belongs to and/or is being used by the user of the ring via the first color of and/or the indicia of the ring. The container may have a lid which is connected to the ring or the tab of the ring via flanges of the lid. The flanges of the lid separate from the ring or the tab of the ring by removing the lid from the container. Each of the other containers have rings displaying different colors than the first color and/or different indicia than the first indicia to identify and/or to distinguish each of the other containers.

### BACKGROUND OF THE INVENTION

The present invention generally relates to a ring, a container and a method for identifying the container. More specifically, the present invention relates to a ring, a container and a method for identifying the container which may attach and/or may connect the ring to a top portion of the container and/or a cap of the container. The ring may have a first portion and/or a second portion defining an interior of the ring for receiving the top portion of the container. The first portion and the second portion may be separated via an opening of the ring for inserting the top portion of the container between the first portion and the second portion and/or into the interior of the ring. A lid of the container may have flanges for connecting the ring and the lid of the container prior to removal of the lid from the container. The ring may be made from a material which may be resilient for moving a first end of the first portion outwardly with respect to a first end of the second portion to insert the top portion of the container into and/or to remove the top portion of the container from the interior of the ring. As a result, the top portion of the container may be located within and/or may be positioned within the interior of the ring for attaching and/or for connecting the ring to the container.

The ring may have a tab extending outwardly with respect to the ring to display indicia and/or to attach ribs to the ring. The indicia may display an advertisement and/or the like. The indicia and/or a shape of perimeter of the tab may identify and/or may be indicative of the container. The indicia, the tab and/or the ring may display a color which may identify and/or may be indicative of the container. A user of the ring may identify and/or may recognize the container from on the indicia displayed on the tab, the shape of the perimeter of the tab and/or the color displayed from the indicia, from the tab and/or from the ring.

A manufacture and/or a distributor of the container may package a number of containers for distributing to the user. Each of the containers may have a lid with flanges for attaching and/or for connecting the ring to the top portion of each of the containers. The lid may be separated from and/or may be detached from the ring by removing the lid from the container. The ring of each of the containers may display a color and/or indicia which may be a different color and/or a different indicia than the colors and/or the indicia displayed on the other rings of the containers. As a result, each container may be identified by the ring which may be attached to the top portion of each container.

It is generally known that vendors and/or retailers sell beverages to consumers in a pack of single serving containers (hereinafter “containers”), such as, for example, plastic bottles, glass bottles and/or the like. The pack may contain a number of containers, such as for example, four containers, six containers, twelve containers or twenty-four containers. Typically, each of the containers has a neck extending outwardly from a base of the container. A lid and/or a cap is attached to an end of the neck and/or the top portion for sealing and/or for closing the containers to store and/or to house the beverage within an interior of each of the containers. The lid and/or the cap of each of the containers within the pack may be identical and/or may be indistinguishable. As a result, a first consumer and/or a second consumer may be unable and/or may be incapable of identifying one of the containers from other containers within the pack.

A first consumer removes the lid and/or the cap from the neck of a first container from the pack to open the first container for consuming and/or for drinking the beverage stored within the interior of the first container. However, the first consumer often fails to consume all of the beverage contained within the interior of the first container and/or may desire to save an unfinished portion of the beverage within the interior of the first container for consuming the beverage at a later time.

The first consumer may place, may position and/or may store the first container in a location for later consumption. However, the container belonging to and/or being consumed by the first consumer may not be labeled and/or may not be identifiable by the first consumer from a second container from the pack being consumed by and/or belonging to a second consumer in the location. The second container belonging to the second consumer may be mistakenly identified by the first consumer as the first container belonging to the first consumer. As a result, the first consumer may mistakenly consume the unfinished portion of the beverage from the second container used by and/or belonging to the second consumer. Bacteria, viruses and/or germs from the second consumer which may contaminate the second container belonging to the second consumer may be accidently passed to, contracted by and/or transferred to the first consumer from the second container belonging to the second consumer. As a result, the first consumer may contract a sickness, an illness and/or a disease from the bacteria, the viruses and/or the germs from the second consumer via the second container of the second consumer.

It is known to display an identifier adjacent to an exterior surface of the container to identify the container, the beverage within the interior of the container and/or an owner of the container. One known identifier is a label in the form of a medallion attached to and/or affixed to an elastic band. The elastic band is sized to receive and/or to encircle an exterior surface of the base of the container. The base of the container is inserted into an interior of the elastic band for connecting the medallion and/or the elastic band to the container. The elastic band contracts inwardly with respect to the exterior surface of the base of the container. As a result, the medallion and/or the elastic band contacts and/or abuts the exterior surface of the base of the container for attaching the elastic band and/or the medallion to the container.

The medallion may identify and/or may be indicative of the container, the beverage within the interior of the container and/or the owner of the container. However, the medallion may made from a first material, such as, for example, a metal and/or the like. The elastic band may be made from a second material, such as, for example, a rubber, a latex and/or the like. As a result, the identifier may be expensive and/or may be costly by using the first material of the medallion and/or the second material of the elastic band for the identifier. Further, assembling of the identifier may be time consuming, burdensome and/or labor intensive. Moreover, attachment of the elastic band and/or the medallion to the exterior surface of the base of the container may be inconvenient to the user and may be problematic for grasping the base of the container. As a result, adding the indicia to the medallion to be indicative of the first consumer may be time consuming and/or may be inconvenient.

A need, therefore, exists for a ring, a container and a method for identifying the container. Additionally, a need exists for a ring, a container and a method for identifying the container which may be inexpensive to and/or simple to manufacture and/or assemble. Further, a need exists for a ring, a container and a method for identifying the container which may have a ring connected to each container within a pack of containers to identify and/or to distinguish each container from other containers of the pack of containers. Still further, a need exists for a ring, a container and a method for identifying the container which may display a color and/or indicia on a tab of the ring and/or on an portion of the ring to identify the container and/or a user of the container. Moreover, a need exists for a ring, a container and a method for identifying the container which may be disposable after removal from the container and/or may be reusable with another container. Additionally, a need exists for a ring, a container and a method for identifying the container which may prevent a first user from consuming and/or from drinking a beverage from the container of a second user to prevent transmission of bacteria, viruses and/or germs between the first user and the second user.

### SUMMARY OF THE INVENTION

The present invention generally relates to a ring, a container and a method for identifying the container. The ring, the container and the method may attach and/or may connect the ring to a top portion of the container and/or to a lid of the container. The ring may have a first portion and/or a second portion defining an interior of the ring for receiving the top portion of the container to connect the ring to the container and/or the lid of the container. An opening may separate an end of the first portion and an end of the second portion for moving the second portion outwardly with respect to the end of the first portion to insert and/or to position the top end of the container into the interior of the ring. The ring may be made from a flexible material and/or resilient material which may allow the second portion to move and/or to bend outwardly and/or inwardly with respect to the first portion without damaging and/or without destroying the ring. Flanges of the lid of the container may connect and/or attach the ring to the container and/or the lid of the container.

The ring may have a tab extending outwardly with respect to the first portion and/or the second portion. Ribs may be located on the tab for grasping by a user to attach the ring to and/or to remove the ring from the container. Indicia may be displayed on the tab for identifying the ring and/or the container which may be connected to the ring. The tab, the first portion of the ring and/or the second portion of the ring may display a color which may identify the ring and/or the container which may be connected to the ring. The user may determine that the container may belong to the user by identifying the sticker on, the indicia on and/or the color associated with the ring and/or the tab. The container may be distinguished from and/or identified from other containers within a pack of containers via the indicia on the ring and/or the color of the ring. Each of container of the pack of containers may have a ring for identifying and/or for distinguishing each container from the other containers within the pack of containers.

To this end, in an embodiment of the present invention,

In an embodiment,

It is, therefore, an advantage of the present invention to provide a ring, a container and a method for identifying the container.

Another advantage of the present invention is to provide a ring, a container and a method for identifying the container which may provide identification of the container from other containers by a user to prevent accidental transmission of bacteria, viruses and/or germs from the other containers to the user.

And, another advantage of the present invention is to provide a ring, a container and a method for identifying the container which may be made from a material which may be cheap and inexpensive.

Yet another advantage of the present invention is to provide a ring, a container and a method for identifying the container which may identify and/or may distinguish two or more containers from each other via the ring of each container.

A further advantage of the present invention is to provide a ring, a container and a method for identifying the container which may be disposable after removal from the container and/or may be reusable attaching to another container.

Moreover, an advantage of the present invention is to provide a ring, a container and a method for identifying the container which may provide portions defining an interior of the ring for receiving a top portion of the container.

And, another advantage of the present invention is to provide a ring, a container and a method for identifying the container which may display a color and/or indicia on the ring and/or on a tab of the ring for indicating that the container belongings to a user of the ring.

Yet another advantage of the present invention is to provide a ring, a container and a method for identifying the container which may provide a tab having ribs for grasping by a user to remove the ring from and/or to attach the ring to the container.

Another advantage of the present invention is to provide an a ring, a container and a method for identifying the container which may provide a tab having a perimeter with a shape for indicating that the container belongings to a user of the ring.

Yet another advantage of the present invention is to provide a ring, a container and a method for identifying the container which may provide an opening of the ring between portions of the ring for inserting a top portion of the container between the portions of the ring.

A still further advantage of the present invention is to a ring, a container and a method for identifying the container which may provide flanges on a lid of the container for connecting the ring to the container and/or to the lid of the container.

Moreover, an advantage of the present invention is to provide a ring, a container and a method for identifying the container which may be made from a flexible material and/or a resilient material for moving a first portion of the ring outwardly or inwardly with respect to the second portion of the ring to connect the ring to the container.

And, another advantage of the present invention is to provide a ring, a container and a method for identifying the container which may provide an interior of the ring having a diameter corresponding to and/or based on a diameter of a top portion of the container.

Yet another advantage of the present invention is to provide a ring, a container and a method for identifying the container which may identify and/or may distinguish each container of a pack of containers via the ring of each container.

Moreover, an advantage of the present invention is to provide a ring, a container and a method for identifying the container which may allow a user to identify that the container belongs to the user from two or more containers of a pack of containers.

And, another advantage of the present invention is to provide ring, the system and a method for identifying the container which prevents a user from mistakenly consuming a beverage from a container not belonging to the user of the ring.

Additional features and advantages of the present invention are described in, and will be apparent from, the detailed description of the presently preferred embodiments and from the drawings.

### BRIEF DESCRIPTION OF THE DRAWINGS

FIG. 1 illustrates a top plan view of a ring for identifying a container in an embodiment of the present invention.

FIG. 2 illustrates a perspective view of a ring for identifying a container in an embodiment of the present invention.

FIG. 3 illustrates a top plan view of a ring for identifying a container in an embodiment of the present invention.

FIG. 4 illustrates a top plan view of a ring for identifying a container in an embodiment of the present invention.

FIG. 5 illustrates a perspective view of a system for identifying a container in an embodiment of the present invention.

FIG. 6 illustrates a perspective view of a lid and a ring for identifying a container in an embodiment of the present invention.

FIG. 7 illustrates a perspective view of a pack of containers for identifying each of containers within the pack of containers in an embodiment of the present invention.

### DETAILED DESCRIPTION OF THE PRESENTLY PREFERRED EMBODIMENTS

The present invention generally relates to a ring, a container and a method for identifying the container. The ring may have a first portion and/or a second portion to define an interior of the ring for receiving a top portion of the container. The ring may have an opening separating a first end of the first portion and a first end of the second portion of the ring for inserting and/or for positioning the top portion of the container into the interior of the ring. The ring may have a tab extending outwardly with respect to the ring for display a color and/or indicia to identify and/or to distinguish the ring from other rings. The color and/or the indicia may be indicative of a user of the container to identify that the container may have been opened by and/or may have been consumed by the user. A lid of a container may be attached to and/or may be connected to the ring via flanges of the lid. The flanges of the lid may be separated from and/or may be detached from the ring by removing the lid from the container.

The ring may be made from a material which may be resilient to facilitate moving the first end of the first portion inwardly and/or outwardly with respect to the first end of the second portion without damaging and/or without destroying the ring. The user may insert the top portion of the container into the interior of the ring via the opening to connect the ring to the container. As a result, the user may identify and/or may recognize the container which may belong to the user from other containers within a pack of containers via the color of the ring and/or the indicia displayed on the ring. Each of the other containers may have other rings which may display a different color than the color of and/or different indicia than the indicia of the ring of the container of the user. As a result, each of the other containers may be identified and/or may be distinguished from each other via the rings attached to the containers.

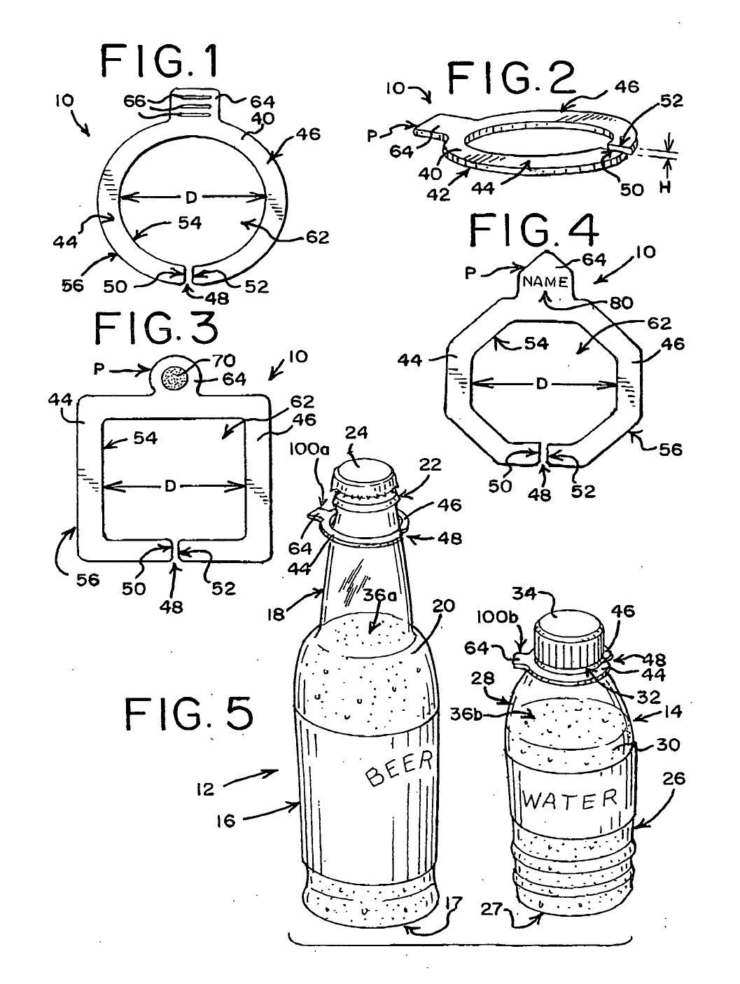

Referring now to the drawings wherein like numerals refer to like parts, FIGS. 1-4 illustrate a ring 10 for identifying a first beverage container 12 (hereinafter “the first container 12”) and/or a second beverage container 14 (hereinafter “the second container 14”) in an embodiment of the present invention. The first container 12 may have a base 16 with a bottom 17, a top portion 18 and/or exterior walls 20 as shown in FIG. 5. The top portion 18 of the first container 12 may be attached to the base 16 and/or may be located opposite to the bottom 17 of the base 16. The first container 12 may have a mouth 22 and/or a lid 24 for closing, for covering and/or for sealing the first container 12. The top portion 18 of the first container 12 may be narrower than the base 16 of the first container 12.

The second container 14 may have a base 26 with a bottom 27, a top portion 28 and/or exterior walls 30. The top portion 28 of the second container 14 may be attached to the base 26 and/or may be located opposite to the bottom 27 of the base 26. The top portion 28 of the second container 14 may be attached to the base 26 and/or may be located opposite to the bottom 27 of the base 26. The first container may have a mouth 32 and/or a lid 34 for closing, for covering and/or for sealing the second container 14. The top portion 28 of the second container 14 may be narrower than the base 26 of the second container 14.

In an embodiment, the first container 12 and/or the second container 14 (hereinafter collectively known as “the container 12, 14”) may be, for example, a bottle and/or the like. In an embodiment, the containers 12, 14 may be made from a material, such as, for example, glass, plastic, aluminum and/or the like. In an embodiment, the first container 12 may have a similar shape and/or a similar size as the second container 14. In an embodiment, the containers 12, 14 may contain a first beverage 36a and/or a second beverage 36b, respectively. In an embodiment, the first beverage 36a and/or the second beverage 36b (hereinafter collectively known as “the beverages 36a, 36b”) may a type of beverage, such as, for example, a juice, a milk, a sports drink, beer, an alcoholic drink, a wine, a fruit drink, a coffee-based drink, water and/or the like. In an embodiment, the first beverage 36a of the first container 12 may be the same type of beverage as the second beverage 36b of the second container 14. The present invention should not be deemed as limited to a specific embodiment of the material of the containers 12, 14 and/or a specific embodiment of the beverages 36a, 36b.

The ring 10 may have a height H defined between a top side 40 and/or a bottom side 42 as shown in FIGS. 1-4. The height 41 of the ring 10 may be within a range of two (2) millimeters (hereinafter “mm”) and four (4) mm. The ring 10 may have a first portion 44 and/or a second portion 46. The ring 10 may have an opening 48 which may be located between an end 50 of the first portion 44 and an end 52 of the second portion 46. The ring 10 may have an interior surface 54 and/or an exterior surface 56. The exterior surface 56 of the ring 10 may be located opposite to the interior surface 54 of the ring 10.

The interior surface 54 of the ring 10 may define an interior 68 of the ring 10. The ring 10 may have a first shape, such as, for example, circle as shown in FIGS. 1 and 2. The interior 62 of the ring 10 may have a diameter D between the first portion 44 of the ring 10 and the second portion 46 of the ring 10. The diameter D of the interior 68 of the ring 10 may correspond to and/or may be sized to receive the top portion 18 of the first container 12 and/or the top portion 28 of the second container 14. In an embodiment, the diameter D of the interior 62 may be between the range of twenty-five (25) mm and thirty-five (35) mm. The interior 62 of the ring 10 may be shaped to correspond to the first shape of the ring 10. As a result, the interior 62 of the ring 10 may be shaped as, for example, a circle.

In an embodiment, the first shape of the ring 10 may be, for example, a rectangle as shown in FIG. 3. As a result, the shape of the interior 62 of the ring 10 may be a rectangular. In an embodiment, the first shape of the ring 10 may be, for example, a polygon, such as, for example, an octagon as shown in FIG. 4. As a result, the interior 62 of the ring 10 may correspond to the shape of the polygon. The present invention should not be deemed as limited to a specific embodiment of the first shape of the ring 10.

The ring 10 may a tab 64 extending outwardly with respect to the exterior surface 56 of the ring 10. The tab 64 of the ring 10 may be located opposite to the opening 48 of the ring 10. The tab 64 of the ring 10 may have a perimeter P which may extend outwardly with respect to the exterior surface 56 of the ring 10. In an embodiment, the perimeter P of the tab 64 may have a shape, such as, for example, a rectangle as shown in FIG. 1, a semi-circle as shown in FIG. 2 and/or a polygon as shown in FIG. 4. The present invention should not be deemed as limited to a specific embodiment of the shape of the perimeter P of the tab 64.

The tab 64 may have ribs 66 located on the top side 40 of the ring 10 as shown in FIG. 1. The ribs 66 may extend outwardly with respect to the top side 40 of the ring 10. In an embodiment, a number of the ribs 66 on the tab 64 may be, for example, three (3), four (4) or five (5). A first user (not shown in the figures) and/or of a second user (not shown in the figures) may engage the ribs 66 on the tab 64 to grasp, to hold and/or to manipulate the ring 10. The ribs 66 may prevent a hand and/or fingers of the first user and/or of the second user from slipping from and/or from releasing the tab 64 during manipulation and/or during handling of the ring 10. The present invention should not be deemed as limited to a specific embodiment of the number of the ribs 66 on the tab 64.

The first portion 44 of the ring 10, the second portion 46 of the ring 10 and/or the tab 64 of the ring 10 may display a first color. In an embodiment, a first ring 110a and/or a second ring 110b (hereinafter collectively known as “rings 110a, 110b”) may display the first color and a second color, respectively, as shown in FIG. 5. The first color and/or the second color may be, such as, for example, white, black, red, orange, yellow, green, light blue, dark blue, purple or gray. The first color of the first ring 110a may be a different color than the second color of the second ring 110b. It should be understood that the first color and/or the second color may be any colors as known to one having ordinary skill in the art.

The ring 10 and/or the rings 110a, 110b may be made from a material which may be resilient, flexible and/or stretchable to facilitate moving the first portion 44 inwardly and/or outwardly with respect to the second portion 46 of the ring 10 and/or the rings 110a, 110b. The material of the ring 10 may have a tensile strength within the range of thirty-eight hundred (3800) pounds per square inch (hereinafter “psi”) and forty-two hundred (4200) psi. The end 50 of the first portion 44 may move inwardly and/or outwardly with respect to the end 52 of the second portion 46 to enlarge and/or to reduce a size of the opening 48 between the end 50 of the first portion 44 and the end 52 of the second portion 46. The size of the opening may be between the range of one (1) mm and ten (10) mm. As a result, the opening 48 may be sized to receive the top portion 18 of the first container 12 to insert the top portion 18 of the first container 12 into the interior 62 of the ring 10 and/or the rings 110a, 110b. The size of the opening 48 of the ring 10 and/or the rings 110a, 110b may be enlarged to insert a top portion of another container (not shown in the figures) which may be larger or smaller than the top portion 18 of the first container 12 into the interior 62 of the ring 10 and/or the rings 110a, 110b.

The top portion 18 of the first container 12 or the top portion 28 of the second container 14 may be inserted into and/or may be positioned within the interior 62 of the ring 10 via the opening 48 of the ring 10 and/or the rings 110a, 110b. The diameter D of the interior 62 may be sized to receive the top portion 18 of the first container 12. Resilient characteristics of the ring 10 and/or the rings 110a, 110b may move and/or may pull the end 52 of the second portion 46 inwardly with respect to the end 50 of the first portion 44 to reduce the size of the opening 48 of the ring 10. The ring 10 and/or the rings 110a, 110b may surround and/or may encircle the first portion 18 of the first container 12 to connect and/or to attach the ring 10 and/or the rings 110a, 110b to first container 12. The resilient characteristics of the ring 10 and/or the rings 110a, 110b may prevent the top portion 18 of the first container 12 from exiting and/or moving outwardly with respect to the interior 62 of the ring 10 via the opening 48. As a result, the ring 10 and/or the rings 110a, 110b may be connected to and/or attached to the first container 12 via the top portion 18 of the first container 12 and/or the arms 44, 46 of the ring 10.

The ring 10 and/or the rings 110a, 110b may be made from a material which may have the resilient characteristics and/or a flexibility to allow movement of the first portion 44 with respect to the second portion 46. The size of the opening 48 of the ring 10 and/or the rings 110a, 110b may be enlarged to receive the top portion 18 of the first container 12 and/or the top portion 28 of the second container 14 without damaging and/or destroying the ring 10 and/or the rings 110a, 110b. As a result, the top portion 18 of the first container 12 and/or the top portion 28 of the second container 14 may be inserted into the interior 62 of the ring 10 and/or the rings 110a, 110b via the opening 48 without damaging and/or destroying the ring 10 and/or the rings 110a, 110b. The resilient characteristics of the ring 10 may move and/or may pull the first arm 44 inwardly with respect to the second arm 46 to connect the ring 10 to the first container 12 without damaging and/or without destroying the ring 10. The ring 10 and/or the rings 110a, 110b may be made from, for example, a polymer, an elastomer, a thermal poly rubber and/or the like. In an embodiment, the ring 10 and/or the rings 110a, 110b may be made from, for example, a polypropylene copolymer, a polyurethane, a poly, a polyethylene and/or the like

In an embodiment, a sticker 70 may be adhered to, may be attached to and/or may be connected to the tab 64 of the ring 10 as shown in FIG. 3. The sticker 70 may be located on the top side 40 and/or the bottom side 42 of the ring 10 and/or the rings 110a, 110b. The sticker 70 may be located within the perimeter P of the tab 64 of the ring 10 and/or the rings 110a, 110b. In an embodiment, indicia 80 may be displayed on and/or may be affixed to the tab 64 of the ring 10 as shown in FIG. 4. The indicia 80 may be located on the top side 40 and/or the bottom side 42 of the ring 10 and/or the rings 110a, 110b. The ring 10 and/or the rings 110a, 110b may be identified by and/or may be recognizable from the sticker 70 of and/or the indicia 80 of the ring 10 and/or the rings 110a, 110b.

The sticker 70 and/or the indicia 80 on the tab 64 may be and/or may display marks, such as, for example, a word, a name, a phrase, a numeral, a numerical sequence, a design, an insignia, a language character, an object, an image, a cartoon, a logo, a trademark and/or the like. The marks may relate to a topic, such as, for example, a cartoon character, an athlete, a musical performer, a political figure, a visual scene, a competition, a written message, a theme and/or the like. Further, the sticker 70 and/or the indicia 80 on the tab 64 may be display the first color and/or the second color. Still further, the sticker 70 and/or the indicia 80 may relate to an entity, such as, for example, an entertainment company, a food manufacturing company, a bottling company, a food processing, an advertising company, a marketing company, a sporting team, an association, a company and/or the like. Moreover, the sticker 70 and/or the indicia 80 on the tab 64 may be, for example, an advertisement, an announcement and/or a broadcast which may relate to the topic, the entity, a name of a person, a name of a group of people and/or the like. As a result, the tab 64 of the ring 10 and/or the rings 110a, 110b may advertise and/or may market the topic, the entity, the person and/or the group of people to the users via the sticker 70 and/or the indicia 80. The present invention should not be deemed as limited to the embodiments of specific marks, specific topics and/or specific entities of the sticker 70 and/or of the indicia 80.

The sticker 70 may have an adhesive backside which may attach to the top side 40 and/or to the bottom side 42 of the ring 10 and/or of the rings 110a, 110b. The indicia 80 may be, for example, screened, printed, embossed and/or stamped onto the top side 40 and/or the bottom side 42 of the ring 10 and/or the rings 110a, 110b. The tab 64 may be molded to contain and/or to display the indicia 80 by a molding procedure, such as, for example, injection molding, compression molding and/or the like. In an embodiment, the indicia 80 may be integrally formed with the ring 10 and/or the rings 110a, 110b via the molding procedure. In an embodiment, the ring 10 and/or the rings 110a, 110b may be molded via the molding procedure. The present invention should not be deemed as limited to the embodiments of a specific method for connecting the sticker 70 and/or the indicia 80 to the tab 64, the ring 10 and/or the rings 110a, 110b.

In an embodiment, the first user and/or the second user (hereinafter collectively known as “the users”) may be assigned, may receive and/or may be distributed the rings 110a, 110b, respectively. The rings 110a, 110b may be indicative of, may be identified with and/or may be representative of the users, respectively. The first color of the first ring 110a, of the sticker 70 on the first ring 110a and/or the indicia 80 on the first ring 110a may be indicative of, may be identified with and/or may be representative of the first user. The second color of the second ring 110b, of the sticker 70 on the second ring 110b and/or the indicia 80 on the second ring 110b may be indicative of, may be identified with and/or may be representative of the second user. The shape of the interior 62 of the first ring 110a and/or the shape of the perimeter P of the tab 64 of the first ring 110a may be indicative of, may be identified with and/or may be representative of the first user. The shape of the interior 62 of the second ring 110b and/or the shape of the perimeter P of the tab 64 of the second ring 110b may be indicative of, may be identified with and/or may be representative of the second user.

The first user may be assigned, may be distributed and/or may receive the first container 12 for consuming and/or for drinking the first beverage 36a from the first container 12 via the mouth 22 of the first container 12. The first user may position the opening 48 of the first ring 110a adjacent to the top portion 18 of the first container 12 for connecting the first ring 110a to the first container 12 via the tab 64 of the first ring 110a. The first user may push and/or may move the top portion 18 of the first container 12 inwardly with respect to the opening 48 between the end 50 of the first portion 44 and the end 52 of the second portion 46 of the first container 110a.

The portions 44, 46 of the first ring 110a may move outwardly with respect to each other for enlarging the opening 48 of the first container 12 to insert the top portion 18 of the first container 12 into the interior 62 of the first ring 110a. The top portion 18 of the first container 12 may move into and/or may be positioned within the interior 62 of the first container 110a. The end 50 of the first portion 44 may move inwardly with respect to the end 52 of the second portion 46 for reducing the opening 48 between the end 50 of the first portion 44 and the end 52 of the second portion 46 of the first ring 110a. The diameter D of the interior 62 may be sized to and/or may be shaped to receive the top portion 18 of the first container 12. As a result, the first ring 110a may be connected to and/or may be attached to the first container via the top portion 18 of the first container 12. The first container 12 may be identified and/or may be recognized as belonging to and/or as being used by the first user via the first ring 110a which may be connected the first container 12.

The first user may remove the lid 24 of the first container 12 to open the first container 12 for consuming and/or for drinking the first beverage 36a from the first container 12 via the mouth 22 of the first container 12. The first user may deposit bacteria, viruses and/or germs on the mouth 22 of the first container 12 by drinking from the first container 12 via the mouth 22 of the first container 12. As a result, the first container 12 and/or the first beverage 36a within the first container 12 may be contaminated by the bacteria, the viruses and/or the germs of the first user. The first user may not drink all of the first beverage 36a contained within the first container 12. The first user may choose to store an unfinished portion of the first beverage 36a within the first container 12. The first user may store and/or may position the first container in a location, such as, for example, on a shelf, on a table, in a box, in a basket, in a ice cooler, in a refrigerator and/or the like. The first ring 110a may be connected to and/or may be attached to the first container 12 to identify, to represent and/or to indicate that the first container 12 may belong to and/or may be used by the first user of the first ring 110a.

The second user may be assigned, may be distributed and/or may receive the second container 14 for consuming and/or for drinking the second beverage 36b from the second container 14 via the mouth 32 of the second container 14. The second user may position the opening 48 of the second ring 110b adjacent to the top portion 18 of the second container 14 for connecting the second ring 110b to the second container 14 via the tab 64 of the second ring 110b. The second user may push and/or may move the top portion 18 of the second container 14 inwardly with respect to the opening 48 between the end 50 of the first portion 44 and the end 52 of the second portion 46 of the second container 110b.

The portions 44, 46 of the second ring 110b may move outwardly with respect to each other for enlarging the opening 48 of the second container 14 to insert the top portion 28 of the second container 14 into the interior 62 of the second ring 110b. The top portion 28 of the second container 14 may move into and/or may be positioned within the interior 62 of the second container 110b. The end 50 of the first portion 44 may move inwardly with respect to the end 52 of the second portion 46 for reducing the opening 48 between the end 50 of the first portion 44 and the end 52 of the second portion 46 of the second ring 110b. The diameter D of the interior 62 may be sized to and/or may be shaped to receive the top portion 18 of the second container 14. As a result, the second ring 110b may be connected to and/or may be attached to the second container 14 via the top portion 18 of the second container 14. The second container 14 may be identified and/or may be recognized as belonging to and/or as being used by the second user by the second ring 110b which may be connected the second container 14.

The second user may remove the lid 34 of the second container 14 to open the second container 14 for consuming and/or for drinking the second beverage 36b from the second container 14 via the mouth 32 of the second container 14. The second user may deposit bacteria, viruses and/or germs on the mouth 32 of the second container 14 by drinking from the second container 14 via the mouth 32 of the second container 14. As a result, the second container 14 and/or the second beverage 36b within the second container 14 may be contaminated by the bacteria, the viruses and/or the germs of the second user. The second user may not drink all of the second beverage 36b contained within the second container 14. The second user may choose to store an unfinished portion of the second beverage 36b. The second ring 110b may be connected to and/or may be attached to the second container 14 to identify, to represent and/or to indicate that the second container 14 may belong to and/or may be used by the second user of the second ring 110b.

The second user may store and/or may position the second container in a location adjacent to the location of the first container 12 of the first user. As a result, the second container 14 of the second user may be positioned and/or may be located adjacent to the first container 12 of the first user at the location. The users may observe and/or may view the first container 12 and/or the second container 14 to determine and/or to identify whether the first container 12 or the second container 14 may belong to and/or may be used by the first user or the second user. The users may be incapable of determining and/or of identifying whether the first container 12 or the second container 14 may belong to, may be used by, may have been opened by and/or may have been consumed by the first user or the second user without observing and/or without viewing the rings 110a, 110b which may be attached to the containers 12, 14, respectively.

The users may observe, may recognize and/or may view the rings 110a, 110b which may be connected to the containers 12, 14, respectively. The first color of the first ring 110a, of the sticker 70 on the first ring 110a and/or of the indicia 80 on the first ring 110a may indicate to and/or may identify to the users that the first container 12 with the first ring 110a may belong to and/or may be used by the first user. The shape of the first ring 110a and/or of the perimeter P of the tab 64 of the first ring 110a may indicate and/or may identify to the users that the first container 12 having the first ring 110a may belong to, may have been opened by, may have been consumed by and/or may be used by the first user. As a result, the users may identify and/or may determine that the first container 12 with the first ring 110a may belong to, may have been opened by, may have been consumed by and/or may be used by the first user via the first ring 110a.

The second color of the second ring 110b, of the sticker 70 on the second ring 110b and/or of the indicia 80 on the second ring 110b may indicate to and/or may identify to the users that the second container 14 having the second ring 110a may belong to and/or may be used by the second user. The shape of the second ring 110b and/or of the perimeter P of the tab 64 of the second ring 110b may indicate to and/or may identify to the users that the second container 14 may belong to and/or may be used by the second user. As a result, the users may identify and/or may determine that the second container 14 with the second ring 110a may belong to, may have been opened by, may have been consumed by and/or may be used by the second user via the second ring 110b. The rings 110a, 110b may be removed from the first container 12 and/or the second container 14 to be disposed of or to be attached to other containers (not shown in the figures).

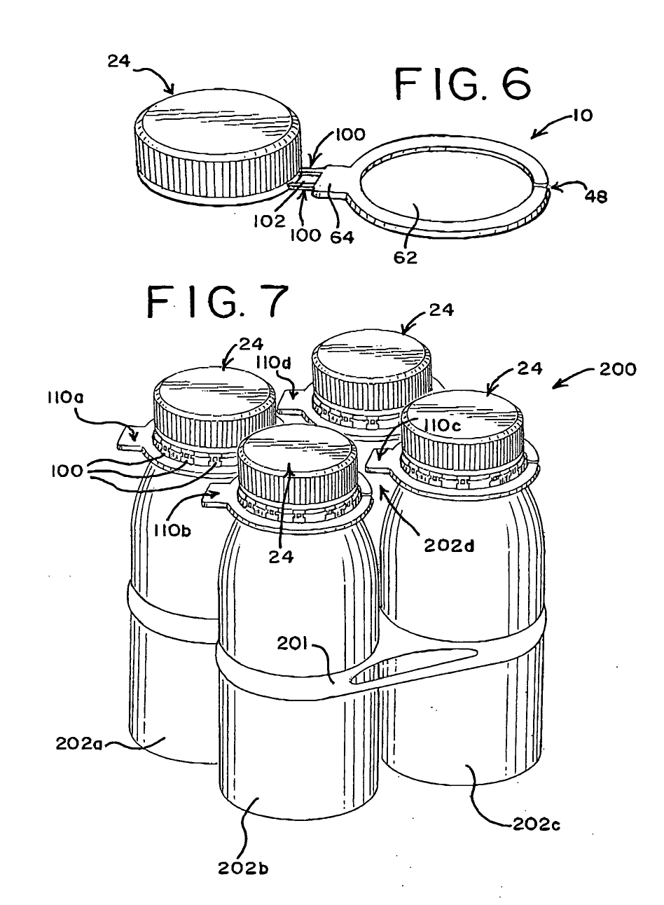

FIG. 6 illustrates the lid 24 of the first container which may be attached to and/or may be connected to the ring 10. A flanges 100 may be connect and/or may attach lid 24 to the tab 64 of the ring 10. Perforations 102 may separate each of the flanges 100 to facilitate separating the lid 24 and the ring 10. The lid 24 and the ring 10 may be attached to and/or may be connected to the first container 12 by the manufacturer and/or the bottler of the first container 12. As a result, the manufacturer and/or the bottler may seal and/or may enclose the first beverage 36a within the first container 12 via the lid 24 with the ring 10 which may be connected to the ring 10 via the flanges 100. The top portion 18 of the first container 12 may be positioned and/or may be inserted within the interior 62 of the first container 12 by the manufacturer and/or the bottler as the first container 12 may be sealed and/or may be enclosed by the lid 24.

The lid 24 may be attached to the mouth 22 of the first container 12 and the top portion 18 of the first container 12 may be positioned within the interior 62 of the first ring 12 without separating the lid 24 and the ring 10. The first user may receive the first container 12 which may have the lid 24 connected to the ring 10 for identifying the first container via the ring 10. As a result, the ring 10 which may be connected to the lid 24 and to the top portion 18 of the first container 12 may indicate to the first user that the first container 12 may belong to and/or may be used by the first user.

The first user may remove, may separate and/or may detach the lid 24 from the first container 12 for consuming the first beverage 36a from the first container 12. The first user may turn and/or may rotate the lid 24 in a first direction to remove the lid 24 from the mouth 22 of the first container 12. The first user may break the flanges 100 between the lid 24 and the ring 10 by turning and/or by rotating the lid 24 in the first direction. The perforation 102 between the flanges 100 may allow the first user to separate the lid 24 and the ring 10 via the flanges 100. The first user may consume the first beverage 36a from the first container 12 via the mouth 22 of the first container 12 with the ring 10 connected to the top portion 18 of the first container 12. As a result, the first user may identify the first container 12 from the second container 14 and/or other containers via the ring 10, the indicia 80 of the ring 10 and/or the first color of the ring 10.

FIG. 7 illustrates a pack 200 of containers 202a-202d which may be packaged via a yoke 201 by the manufacturer, the bottler and/or a distributor for sale and/or for distribution at an establishment, such as, for example, a retail establishment, a whole-sale establishment and/or the like. Each of the containers 202a-202d may contain the first beverage 36a for consuming by a third user (not shown in the figures) and/or a forth user (not shown in the figures), the first user and/or the second user (hereinafter collectively known as “the group of users”). Each of the containers 202a-202d may have the base 16, the top portion 18, mouth 22 and/or the lid 24. The pack 200 may have contain, for example, six containers, twelve containers or twenty-four containers. The present invention should not be deemed as limited to a specific embodiment of the establishment. It should be understood that pack 200 may contain any number of containers as known to one of ordinary skill in the art.

The container 202a may have the first ring 110a for identifying and/or to distinguish the container 202a from the containers 202b-202d of the pack 200. The first portion 18 of the container 202a may be located within and/or may be position within the interior 62 of the first ring 110a. The first ring 110a may be connected to and/or may be attached to the lid 24 of the container 202a via flanges 204a. The flanges 204a may be located between the top side 40 of the first ring 110a and the lid 24 of the container 202a. The container 202a may be sealed by the lid 24 and the top portion 18 of the container 202a may be located within the interior 62 of the first ring 110a. The tab 64 of the first ring 110a, the indicia 80 on the first ring 110a and/or the arms 44, 46 of the first ring 110a may display the first color which may be indicative of and/or may identifying the first ring 110a and/or container 202a.

The group of users may identify the container 202a from the containers 202b-202d via the first color displayed by the first ring 110a, by the indicia 80 on the first ring 110a and/or by the tab 64 of the first ring 110a. The container 202a may be distributed to the first user for consuming the first beverage 36a from the container 202a. The first color of the first ring 110a may be indicative of the container 202a and/or the first user to identify the container 202a from containers 202b-202d. As a result, the group of users may identify and/or may recognize the container 202a of the first user by the first color displayed via the first ring 202a.

The container 202b may have the second ring 110b for identifying and/or to distinguish the container 202b from the containers 202a, 202c, 202d of the pack 200. The first portion 18 of the container 202b may be located within and/or may be position within the interior 62 of the second ring 110b. The second ring 110b may be connected to and/or may be attached to the lid 24 of the container 202b via flanges 204b. The flanges 204b may be located between the top side 40 of the second ring 110b and the lid 24 of the container 202b. The container 202b may be sealed by the lid 24 and the top portion 18 of the container 202a may located within the interior 62 of the first ring 110a. The tab 64 of the second ring 110b, the indicia 80 on the second ring 110b and/or the arms 44, 46 of the second ring 110b may display the second color which may be indicative of and/or may identifying the second ring 110b and/or container 202b.

The group of users may identify the container 202b from the containers 202a, 202c, 202d via the second color displayed by the second ring 110b, by the indicia 80 on the second ring 110b and/or by the tab 64 of the second ring 110b. The container 202b may be distributed to the second user for consuming the first beverage 36a from the container 202b. The second color of the second ring 110b may be indicative of the container 202b and/or the second user to identify the container 202b from containers 202a, 202c, 202d. As a result, the group of users may identify and/or may recognize the container 202b of the second user by the second color displayed via the second ring 202b.

The container 202c may have a third ring 110c for identifying and/or to distinguish the container 202c from the containers 202a, 202b, 202d of the pack 200. The first portion 18 of the container 202c may be located within and/or may be position within the interior 62 of the third ring 110c. The third ring 110c may be connected to and/or may be attached to the lid 24 of the container 202c via flanges 204c. The flanges 204c may be located between the top side 40 of the third ring 110c and the lid 24 of the container 202c. The container 202c may be sealed by the lid 24 and a top portion 18 of the container 202c may located within an interior 62 of the third ring 110c. A tab 64 of the third ring 110c, indicia 80 on the third ring 110c and/or arms 44, 46 of the third ring 110c may display a third color which may be indicative of and/or may identifying the third ring 110c and/or the container 202c. The third color may be a different color than the first color of the first ring 110a and/or the second color of the second ring 110b.

The group of users may identify the container 202c from the containers 202a, 202b, 202d via the third color displayed by the third ring 110c, by the indicia 80 on the third ring 110c and/or by the tab 64 of the third ring 110c. The container 202c may be distributed to the second user for consuming the first beverage 36a from the container 202c. The third color of the third ring 110c may be indicative of the container 202c and/or the third user to identify the container 202c from containers 202a, 202b, 202d. As a result, the group of users may identify and/or may recognize the container 202c of the second user by the third color displayed via the third ring 202c.

The container 202d may have a fourth ring 110d for identifying and/or to distinguish the container 202d from the containers 202a, 202b, 202c of the pack 200. The first portion 18 of the container 202d may be located within and/or may be position within the interior 62 of the fourth ring 110d. The fourth ring 110d may be connected to and/or may be attached to the lid 24 of the container 202d via flanges 204d. The flanges 204d may be located between the top side 40 of the fourth ring 110d and the lid 24 of the container 202d. The container 202d may be sealed by the lid 24 and a top portion 18 of the container 202d may located within an interior 62 of the fourth ring 110d. A tab 64 of the fourth ring 110d, indicia 80 on the fourth ring 110d and/or arms 44, 46 of the fourth ring 110d may display a fourth color which may be indicative of and/or may identifying the fourth ring 110d and/or the container 202d. The fourth color may be a different color than the first color of the first ring 110a, the second color of the second ring 110b and/or the third color of the third ring 110c.

The group of users may identify the container 202d from the containers 202a, 202b, 202c via the fourth color displayed by the fourth ring 110d, by the indicia 80 on the fourth ring 110d and/or by the tab 64 of the fourth ring 110d. The container 202d may be distributed to the second user for consuming the first beverage 36a from the container 202d. The fourth color of the fourth ring 110d may be indicative of the container 202d and/or the fourth user to identify the container 202d from containers 202a, 202c, 202d. As a result, the group of users may identify and/or may recognize the container 202c of the second user by the third color displayed via the third ring 202c.

The first user, the second user, the third user and/or the fourth user may open the containers 202a-202d, respectively, to consume the first beverage 36a from each of the containers 202a-202d by removing the lid 24 from each of the containers 202a-202d. As a result, the flanges 204a-204d may break to separate the lid 24 of each of the containers 202a-202d from the rings 110a-110d, respectively. The group of users may identify each of the containers 202a-202d via the first color of the first ring 110a, the second color of the second ring 110b, the third color of the third ring 110c and/or the fourth color of the fourth ring 110d. As a result, the group of users may identify each of the containers 202a-202d via the rings 110a-110d.

The ring 10 may have the first portion 44 and/or the second portion 46 defining an interior 62 for receiving the top portion 18 of the first container 12. The ring 10 may have the opening 48 for separating the first end 50 of the first portion 44 and the first end 52 of the second portion 52 for inserting the top portion 18 of the first container 12 into the interior 62 of the ring 10. The tab 64 may be connected to the ring 10 to grasp and/or to hold the ring 10 for attaching the ring 10 to the first container 12 and/or for removing the ring 10 from the first container 12. The first user may move the end 50 of the first portion 44 outwardly with respect to the end 52 of the second portion 46 to separate the first portion 44 and the second portion 46 for inserting the top portion 18 of the first container 12 into the interior 62 of the ring 10. The ring 10 and/or the tab 64 of the ring 10 may display the first color, the sticker 70 and/or the indicia 80 which may be indicative of the first user for identifying that the ring 10 and/or the first container 12 with the ring 10 may be used by and/or may belong to the first user of the ring 10. As a result, the first user may identify and/or may recognize that the first container 12 may belong to the first user of the ring 10 via the first color of the ring, the sticker 70 of the ring 10 and/or the indicia 80 of the ring 10.

It should be understood that various changes and modifications to the presently preferred embodiments described herein will be apparent to those skilled in the art. Such changes and modifications may be made without departing from the spirit and scope of the present invention and without diminishing its attendant advantages. It is, therefore, intended that such changes and modifications be covered by the appended claims.

I claim:

1. A ring for identifying a container wherein the ring has a height defined between a top side and a bottom side wherein the height of the ring is within a range of two millimeter and four millimeters, the ring comprising:
a first portion having a length defined between a first end of the first portion and a second end of the first portion;
a second portion having a length defined between a first end of the second portion and a second end of the second portion wherein the first end of the first portion is adjacent to the first end of the second portion wherein the first portion and the second portion define an interior between the first portion and the second portion wherein the interior is circular wherein the interior has a diameter which is within a range of twenty-five millimeters and thirty-five millimeters wherein an opening is located between the second end of the first portion and the second end of the second portion wherein a size of the opening is enlarged by moving the second end of the second portion outwardly with respect to the second end of the first portion; and
a tab which is adjacent to the first end of the first portion and the first end of the second portion wherein the tab is located opposite to the opening wherein the first portion, the second portion and the tab are made from a copolymer.

2. The ring of claim 1 further comprising:
a plurality of ribs formed on the tab wherein the plurality of ribs extends outwardly with respect to the tab.

3. The ring of claim 1 wherein the copolymer is polypropylene.

4. The ring of claim 1 wherein the copolymer is a tensile strength in a range of thirty-eight hundred pounds per square inch and forty-two hundred pounds per square inch.

5. The ring of claim 1 further comprising:
indicia displayed on the tab wherein the indicia is one of a word, an advertisement, a logo, a name, a phrase, a numeral, a numerical sequence and a design.

6. A container having a length defined between a bottom side and a mouth of the container wherein the container has a base adjacent to the bottom side of the container and a top portion adjacent to the mouth of the container wherein the top portion has a first diameter, the container comprising:
a lid;
a ring having a height defined between a top side and a bottom side wherein the height of the ring is within a range of two millimeters and four millimeters wherein the ring has a thickness defined between an interior surface of the ring and an exterior surface of the ring wherein the interior surface defines an interior of the ring wherein the ring has a first end and a second end wherein the first end of the ring is located opposite to the second end of the ring wherein the ring has an opening extending from the exterior surface of the ring to the interior surface of the ring wherein the opening of the ring is located between the first end of the ring and the second end of the ring wherein the ring is made from a material having a tensile strength in a range of thirty-eight hundred pounds per square inch and forty-two hundred pounds per square inch wherein the opening of the ring is enlarged by moving the first end of the ring outwardly with respect to the second end of the ring; and
a flange connecting the ring and the lid wherein the ring is removably attached to the lid via the flange.

7. The container of claim 7 wherein the ring has a tab located opposite to the opening of the ring wherein the tab extends outwardly with respect to the exterior surface of the ring.

8. The system of claim 7 wherein the ring has a plurality of ribs extending outwardly with respect to the top side of the ring.

9. The system of claim 7 further comprising:
indicia displayed on the ring wherein the indicia is one of a word, an advertisement, a logo, a name, a phrase, a numeral, a numerical sequence and a design.

10. The system of claim 7 wherein the material of the ring is polypropylene copolymer.

11. A method for identifying a plurality of containers, the method comprising the steps of:
providing a first container and a second container wherein the first container has a length defined between a mouth of the first container and a bottom side of the first container wherein the fist container has a first top portion adjacent to the mouth of the first container wherein the second container has a length defined between a mouth of the second container and a bottom side of the second container wherein the second container has a second top portion adjacent to the mouth of the second container;
connecting a first ring to the first container wherein the first ring has an exterior surface and an interior surface which defines a first interior of the first ring wherein the first ring has a first end and a second end wherein the first end of the first ring is located opposite to the second end of the first ring wherein the ring has an opening extending from the exterior surface of the first ring to the interior surface of the first ring wherein the opening of the first ring is located between the first end of the first ring and the second end of the second ring wherein the opening of the first ring is enlarged by moving the first end of the first ring outwardly with respect to the second end of the first ring wherein the first top portion of the first container is located within the interior of the first ring wherein the first ring is a first color wherein the first color is indicative of the first container; and
providing a second ring having an exterior surface and an interior surface which defines an interior of the second ring wherein the second ring has a first end and a second end wherein the second end of the second ring is located opposite to the first end of the second ring wherein the ring has an opening extending from the exterior surface of the second ring to the interior surface of the second ring wherein the opening is located between the first end of the second ring and the second end of the second ring wherein the interior of the second ring is sized to receive the second top portion of the second container via the opening of the second ring wherein the second ring is a second color wherein the second color is a different color than the first color of the first ring wherein the second color is indicative of the second container.

12. The method of claim 11 further comprising the step of:
attaching a lid to the mouth of the first container wherein the lid is connected to the first ring.

13. The method of claim 11 further comprising the step of:
identifying the first container by the first color of the first ring.

14. The method of claim 11 further comprising the step of:
inserting the second top portion of the second container into the interior of the second ring via the opening in the second ring.

15. The method of claim 11 wherein the first ring has a tab which is located opposite to the opening of the first ring.

16. The method of claim 11 further comprising the step of:
identifying the second container by the second color of the second ring.

17. The method of claim 11 further comprising the step of:
attaching a yoke to the first container and the second container wherein the first container is identifiable via the first color of the first ring and the second container is identifiable via the second color of the second ring.

18. The method of claim 11 further comprising the step of:
displaying indicia on the first ring wherein the indicia displays one of a word, an advertisement, a logo, a name, a phrase, a numeral, a numerical sequence and a design.

19. The method of claim 11 further comprising the step of:
enlarging the opening of the first ring by moving the first end of the first ring outwardly with respect to the second end of the first ring.

20. The method of claim 11 wherein the first ring is made from a material having a tensile strength in a range of thirty-eight hundred pounds per square inch and forty-two hundred pounds per square inch.
